(19) United States
(12) Patent Application Publication
(10) Pub. No.: US 2017/0154262 A1
(43) Pub. Date: Jun. 1, 2017

(54) RESIZING NEURAL NETWORKS

(71) Applicant: Google Inc., Mountain View, CA (US)

(72) Inventors: David Sussillo, Portola Valley, CA (US); Gregory Sean Corrado, San Francisco, CA (US)

(21) Appl. No.: 14/954,683

(22) Filed: Nov. 30, 2015

(51) Int. Cl. G06N 3/08

(52) U.S. Cl. CPC G06N 3/082

(57) ABSTRACT

Methods, systems, and apparatus, including computer programs encoded on computer storage media, for resizing neural network layers, the method including obtaining data specifying a trained neural network, wherein the neural network comprises one or more neural network layers; reducing a size of one or more of the neural network layers to generate a resized neural network, including: selecting one or more neural network layers for resizing; for each selected neural network layer: determining an effective dimensionality reduction for the neural network layer; based on the determined effective dimensionality reduction, resizing the neural network layer; and retraining the resized neural network.

### BACKGROUND

This specification relates to training neural networks.

Neural networks are machine learning models that employ one or more layers to predict an output for a received input. Some neural networks include one or more hidden layers in addition to an output layer. The output of each hidden layer is used as input to the next layer in the network, i.e., the next hidden layer or the output layer. Each layer of the network has a respective size and generates an output from a received input in accordance with current values of a respective set of parameters.

### SUMMARY

In general, one innovative aspect of the subject matter described in this specification can be embodied in methods for obtaining data specifying a trained neural network, wherein the neural network comprises one or more neural network layers; reducing a size of one or more of the neural network layers to generate a resized neural network, comprising: selecting one or more neural network layers for resizing; for each selected neural network layer: determining an effective dimensionality reduction for the neural network layer; based on the determined effective dimensionality reduction, resizing the neural network layer; and retraining the resized neural network.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations reducing a size of one or more of the neural network layers comprises reducing a number of units in the respective neural network layer.

In some implementations determining an effective dimensionality reduction for the neural network layer comprises providing multiple data inputs to the neural network; processing the input through the neural network layers to generate a respective layer activation at each neural network layer for each data input; and determining an effective dimensionality reduction for the selected neural network layer using the network activations at the selected neural network layer.

In other implementations determining an effective dimensionality reduction for the selected neural network layer using the layer activations at the selected neural network layer comprises performing a Principal Components Analysis (PCA) on the layer activations to generate an eigenvalue spectrum for the network activation; selecting a cut-off for the PCA eigenvalue spectrum; and setting the effective dimensionality reduction as the number of cut-off PCA eigenvalue dimensions.

In some cases selecting a cut-off for the PCA eigenvalue spectrum comprises selecting a cut-off based on a threshold of the cumulative variance of the PCA eigenvalue spectrum

In other cases selecting a cut-off for the PCA eigenvalue spectrum comprises selecting a cut-off level based on a flattening of the PCA eigenvalue spectrum.

In some cases selecting a cut-off for the PCA eigenvalue spectrum comprises selecting a cut-off level based on a predetermined minimal PCA variance and size of the previous neural network layer readout weights.

In some implementations determining an effective dimensionality reduction for the selected neural network layer using the layer activations at the selected neural network layer comprises performing a dimensionality reduction technique that produces a spectrum of variances.

In other implementations the method further comprises reinitializing the resized neural network prior to retraining the resized neural network.

The subject matter described in this specification can be implemented in particular embodiments so as to realize one or more of the following advantages.

A neural network system implementing neural network resizing optimizes the integral number of units in one or more neural network layers, thus reducing required computational resources and reducing the computational costs associated with the neural network system. For example, a neural network system implementing neural network resizing may avoid the need to select overly large sizes of the neural network layers, thus reducing computational resources required and computational costs at both the training stage of the neural network and the inference stage.

Furthermore, a neural network system implementing neural network resizing may avoid the need to select the sizes of the neural network layers at random, thus improving the accuracy of the neural network system. In addition, a neural network system implementing neural network resizing may not require trial and error searching, e.g., manually or programmatically searching, of the space of network layer sizes in order to determine optimal neural network layer sizes, thus avoiding the need of extensive computational resources.

A neural network system implementing neural network resizing may achieve similar or reduced model error rates compared to larger neural network systems that have not implemented neural network resizing. In addition, a neural network system implementing neural network resizing may require less training trials, e.g., two training trials, to determine an optimal set of neural network layer sizes than a neural network system that does not implement neural network resizing which may require a large number of training trials to determine a corresponding optimal set of neural network layer sizes.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example of a neural network resizing system.

FIG. 2 is a flow diagram of an example process for generating a resized neural network.

FIG. 3 is a flow diagram of an example process for resizing a neural network layer.

Like reference numbers and designations in the various drawings indicate like elements.

### DETAILED DESCRIPTION

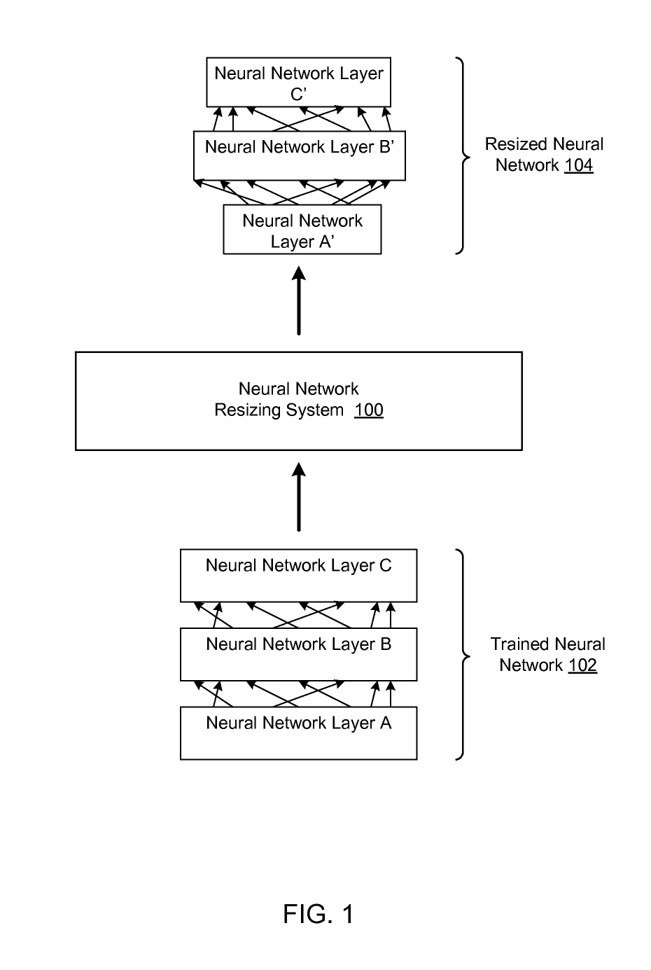

FIG. 1 shows an example neural network resizing system 100. The neural network resizing system 100 is an example of a system implemented as computer programs on one or more computers in one or more locations, in which the systems, components, and techniques described below can be implemented.

The neural network resizing system 100 is a system that receives data specifying a trained neural network 102 and generates as an output data specifying a resized neural network 104.

The trained neural network 102 includes multiple neural network layers, e.g., neural network layer A, neural network layer B and neural network C. One or more of the neural network layers may be hidden neural network layers. Each of the layers of the trained neural network is configured to receive a respective layer input, e.g., an output generated by another layer, an input to the neural network, or both, and process the layer input to generate a respective layer output, i.e., a layer activation, from the input. Each neural network layer includes a respective number of units that specifies the size, or width, of the neural network layer. Each unit in the neural network layer is configured to receive a unit input, e.g., some or all of the respective layer input, and generate a unit output from the input. The respective layer activation is a combination of the generated unit outputs.

Some or all of the layers of the trained neural network are associated with a respective parameter matrix, or weight matrix, that stores trained values of the parameters, or weights, of the neural network layer. For example, the parameters of each unit in a neural network layer correspond to a respective row in the weight matrix for the neural network layer. The neural network layers generate outputs from inputs in accordance with the trained values of the parameters for the neural network layer. For example, as part of generating an output from the received input, a respective unit may multiply the row of the weight matrix corresponding to the unit by its input to generate a unit output. In some implementations an activation function may be applied to the unit output to generate a respective component of a layer activation.

The neural network resizing system 100 receives data specifying the trained neural network 102 and resizes one or more of the neural network layers, e.g., neural network layer A, neural network layer B and neural network C, to generate corresponding resized neural network layers, e.g., neural network layer A′, neural network layer B′ and neural network C′. The corresponding resized neural network layers constitute a resized neural network.

The neural network resizing system 100 can reinitialize the resized neural network by setting the values of the parameters of the resized neural network to initial values, e.g., values selected at random. The neural network resizing system can train the resized neural network using training examples in order to determine trained values of the parameters of the resized neural network layers, i.e., to adjust the values of the parameters from initial values to trained values. For example, during the training, the neural network resizing system 100 can process a batch of training examples and generate a respective resized neural network output for each training example in the batch. The resized neural network outputs can then be used to adjust the values of the parameters of the resized neural network, for example, through gradient descent and back-propagation neural network training techniques.

The resized neural network 104 includes multiple resized neural network layers, e.g., neural network layer A′, neural network layer B′ and neural network layer C′. Each resized neural network layer includes a respective resized number of hidden units that specifies the size, or width, of the neural network layer. The resized number of hidden units is smaller than or equal to the corresponding number of hidden units in the trained neural network 102. For example, the neural network layer A in the trained neural network 102 may have a first number of hidden units, and the corresponding neural network layer A′ in the resized neural network 104 may have a second number of hidden units, where the second number is smaller than or equal to the first number. In some implementations the number of hidden units in each layer of the resized neural network 104 may be the same. In other implementations the number of hidden units in each layer of the resized neural network 104 may vary.

The neural network resizing system 100 generates as output data specifying the retrained, resized neural network 104. The resized neural network 104 may be provided for use, e.g., for processing a new neural network input through the resized neural network layers to generate a new resized neural network output for the input in accordance with the trained values of the parameters of the resized neural network 104.

The trained neural network 102 and the retrained, resized neural network 104 can be configured to receive any kind of digital data input and to generate any kind of score or classification output based on the input.

For example, if the inputs to the trained neural network 102 and the retrained, resized neural network 104 are images or features that have been extracted from images, the output generated by the trained neural network 102 and the retrained, resized neural network 104 for a given image may be scores for each of a set of object categories, with each score representing an estimated likelihood that the image contains an image of an object belonging to the category.

As another example, if the inputs to the trained neural network 102 and the retrained, resized neural network 104 are features of a personalized recommendation for a user, e.g., features characterizing the context for the recommendation, e.g., features characterizing previous actions taken by the user, the output generated by the trained neural network 102 and the retrained, resized neural network 104 may be a score for each of a set of content items, with each score representing an estimated likelihood that the user will respond favorably to being recommended the content item.

As another example, if the input to the trained neural network 102 and the retrained, resized neural network 104 is text in one language, the output generated by the trained neural network 102 and the retrained, resized neural network 104 may be a score for each of a set of pieces of text in another language, with each score representing an estimated likelihood that the piece of text in the other language is a proper translation of the input text into the other language.

As another example, if the input to the trained neural network 102 and the retrained, resized neural network 104 is a spoken utterance, a sequence of spoken utterances, or features derived from one of the two, the output generated by the trained neural network 102 and the retrained, resized neural network 104 may be a score for each of a set of pieces of text, each score representing an estimated likelihood that the piece of text is the correct transcript for the utterance or sequence of utterances.

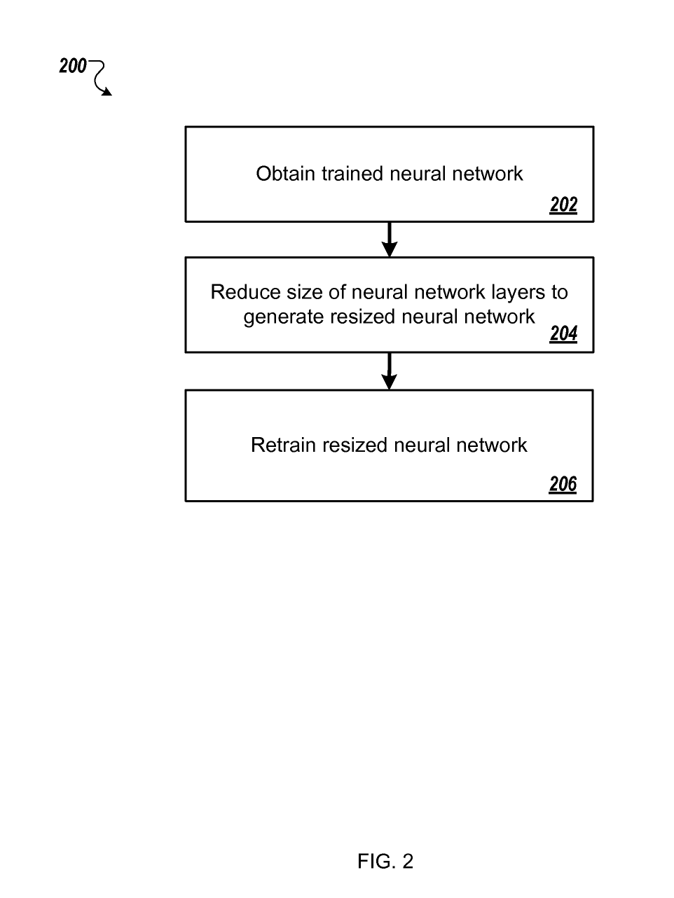

FIG. 2 is a flow diagram of an example process for generating a resized neural network. For convenience, the process 200 will be described as being performed by a system of one or more computers located in one or more locations. For example, a neural network resizing system, e.g., the neural network resizing system 100 of FIG. 1, appropriately programmed in accordance with this specification, can perform the process 200.

The system obtains data specifying a trained neural network, e.g., the trained neural network 102 of FIG. 1 (step 202). The trained neural network includes one or more neural network layers, e.g., the neural network layers A-C of FIG. 1. Each neural network layer has a respective layer size. For example, each neural network layer in the trained neural network may include several thousand units. In some implementations the trained neural network is a recurrent neural network. In other implementations the trained neural network is a feed forward neural network.

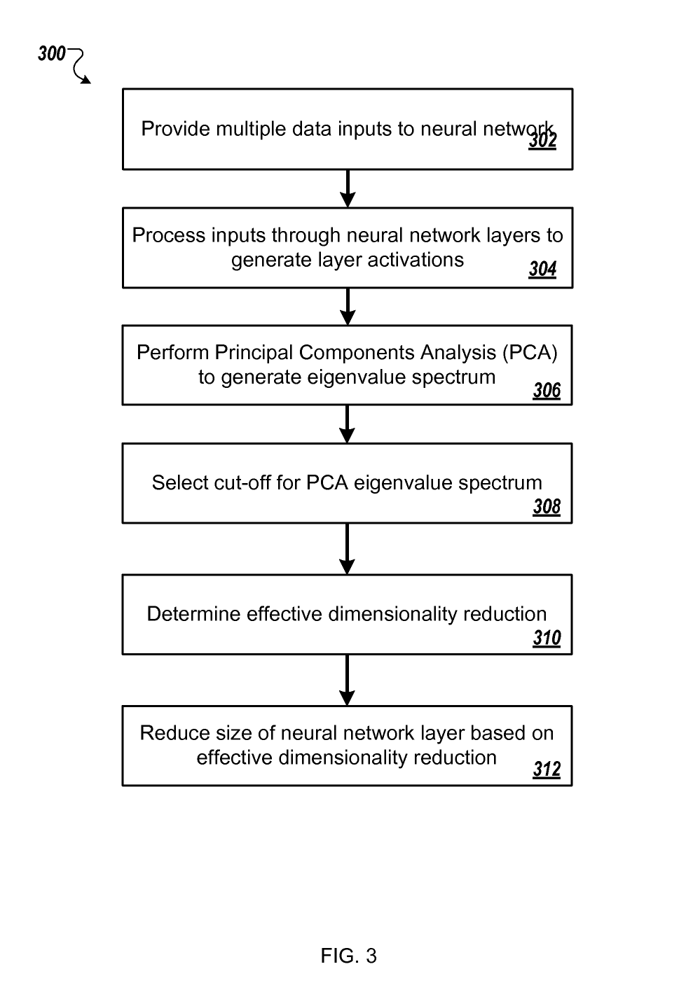

The system reduces the size one or more of the neural network layers to generate a resized neural network (step 204). The system reduces the size of one or more of the neural network layers by reducing a number of units in the respective neural network layer. In some implementations, the system may select one or more neural network layers for resizing. For example, the system may receive an input specifying one or more of the layers to resize. In other examples, the system may receive an input specifying that all neural network layers are to be resized. For each selected neural network layer, the system may determine an effective dimensionality reduction for the neural network layer and, based on the determined effective dimensionality reduction, resize the neural network layer. In some implementations the system may determine an effective dimensionality reduction using Principal Components Analysis (PCA). In other implementations the system may use other techniques, such as random projections or reconstruction error from linear reconstruction to determine an effective dimensionality reduction. The size of the resized neural network layer will be smaller than the size of the neural network layer prior to resizing. For example, continuing the example above, the resized neural network layers may have respective sizes N₁, N₂, . . . , N_{L} with Nᵢ≦N, i=1, . . . , L, where L is the total number of neural network layers. Resizing a neural network layer using PCA is described in more detail below with reference to FIG. 3.

The system retrains the resized neural network (step 206). In some implementations the system may reinitialize the values of the parameters of the resized neural network prior to retraining the resized neural network, e.g., by assigning randomly selected values to the neural network parameters.

FIG. 3 is a flow diagram of an example process for resizing a neural network layer in a trained neural network. For convenience, the process 300 will be described as being performed by a system of one or more computers located in one or more locations. For example, a neural network resizing system, e.g., the neural network resizing system 100 of FIG. 1, appropriately programmed in accordance with this specification, can perform the process 300.

The system provides multiple data inputs to a trained neural network, e.g., the trained neural network 102 of FIG. 1 (step 302). The multiple data inputs can, for example, be a large batch of data inputs.

The system processes the multiple data inputs through the neural network layers of the trained neural network to generate a respective layer activation for each neural network layer for each data input in the batch of data inputs (step 304). For example, for a data input defined as a data input matrix X_{UB} with dimensions U×B, a layer activation for the i-th neural network layer over the input data may be defined as Y_{NB}ⁱ with dimensions N×B.

The performs a Principal Components Analysis (PCA) on the layer activations of the selected neural network layer and generates an eigenvalue spectrum for the neural network layer (step 306). The PCA of Y_{NB}ⁱ may then be defined by the eigenvalues and eigenvectors of the correlation matrix C, defined by C=Y_{NB}ⁱ(Y_{NB}ⁱ)^{T}, with eigenvectors V_{NN} arranged as columns and eigenvalue spectrum {λ₁, . . . , λₙ} arranged from largest to smallest.

The system selects a cut-off for the PCA eigenvalue spectrum (step 308). A PCA dimension that exceeds or equals the selected cut-off for the PCA eigenvalue spectrum represents a minimally useful PCA dimension. For example, let the weights of the i-th neural network layer be given by W and let \tilde{W}=V^{T}W. An estimate for the usefulness of a PCA dimension may be given by \sqrt{|\tilde{W}|ⱼλⱼ}, where |\tilde{W}|ⱼ is the norm of the j-th projection of W into V. The system may select a cut-off for the PCA eigenvalue spectrum by setting a basic minimum threshold on the numbers \sqrt{|\tilde{W}|ⱼλⱼ}, thus yielding a series of layer sizes that minimally impact the network in comparison to a network trained with all layers set to N, for example.

In some implementations, the system selects an arbitrary cut-off level for the PCA eigenvalue spectrum based on a flattening of the PCA eigenvalue spectrum. For example, the eigenvalue spectrum may be modeled as an exponential decay with one or more time constants, and the eigenvalue spectrum may flatten at an exponential pace in the tail. Since the tail may represent a part of state space that may be minimally useful, the system may select an appropriate cut-off level based on the flattening of the PCA eigenvalue spectrum.

In other implementations, the system selects an arbitrary cut-off level for the PCA eigenvalue spectrum based on a threshold of the cumulative variance of the PCA eigenvalue spectrum, e.g., 99% of the cumulative variance.

In other implementations, the system selects a cut-off level for the PCA eigenvalue spectrum based on an arbitrary minimal PCA variance and size of the previous neural network layer readout weights. For example, if the variance in a PCA dimension is small, and the readout weights of the previous neural network layer are of a given size, the dimensions containing variances smaller than the threshold may not be useful.

The system determines an effective dimensionality reduction for the neural network layer using the layer activation at the neural network layer (step 310). For example, the system may set the effective dimensionality reduction for the neural network as the number of cut-off PCA eigenvalue dimensions, as described above with reference to step 308.

The system reduces the size of the neural network layer based on the effective dimensionality reduction (step 312). For example, the system may reduce the size of the neural network layer by reducing the number of layer dimensions by the effective dimensionality reduction determined in step 310, that is by removing a number of units in the neural network layer that is equal to the effective dimensionality reduction. The size of the resized neural network layer, e.g., the number of units in the resized neural network layer, is smaller than the size of the neural network layer, e.g., the number of units in the neural network layer, prior to resizing.

In some implementations, the resizing process 300 can be performed for each neural network layer in the trained neural network, e.g., by repeatedly performing steps 306-312 for each neural network layer in the trained neural network. In other implementations the resizing process may be performed for a single neural network layer, and step 312 repeated for one or more additional neural network layers, i.e., the same effective dimensionality reduction determined in step 310 may be applied to one or more additional neural network layers in the trained neural network.

In other implementations, the resizing process can be performed using alternative techniques for measuring the effective dimensionality of the layer activation generated in step 304. For example, instead of PCA, other dimensionality reduction techniques that also produce a spectrum of variances may be used to determine an effective dimensionality reduction.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., as a result of the user interaction, can be received from the user device at the server.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
obtaining data specifying a trained neural network, wherein the neural network comprises one or more neural network layers;
reducing a size of one or more of the neural network layers to generate a resized neural network, comprising:
selecting one or more neural network layers for resizing;
for each selected neural network layer:
determining an effective dimensionality reduction for the neural network layer, and
based on the determined effective dimensionality reduction, resizing the neural network layer; and
retraining the resized neural network.

2. The method of claim 1, wherein reducing a size of one or more of the neural network layers comprises reducing a respective number of units in each of the one or more neural network layers.

3. The method of claim 1, wherein determining an effective dimensionality reduction for the neural network layer comprises:
providing multiple data inputs to the neural network;
processing the input through the neural network layers to generate a respective layer activation at each neural network layer for each data input; and
determining an effective dimensionality reduction for the selected neural network layer using the network activations at the selected neural network layer.

4. The method of claim 3, wherein determining an effective dimensionality reduction for the selected neural network layer using the layer activations at the selected neural network layer comprises:
performing a Principal Components Analysis (PCA) on the layer activations to generate an eigenvalue spectrum for the network activation;
selecting a cut-off for the PCA eigenvalue spectrum; and
setting the effective dimensionality reduction as the number of cut-off PCA eigenvalue dimensions.

5. The method of claim 4, wherein selecting a cut-off for the PCA eigenvalue spectrum comprises selecting a cut-off based on a threshold of the cumulative variance of the PCA eigenvalue spectrum

6. The method of claim 4, wherein selecting a cut-off for the PCA eigenvalue spectrum comprises selecting a cut-off level based on a flattening of the PCA eigenvalue spectrum.

7. The method of claim 4, wherein selecting a cut-off for the PCA eigenvalue spectrum comprises selecting a cut-off level based on a predetermined minimal PCA variance and size of the previous neural network layer readout weights.

8. The method of claim 3, wherein determining an effective dimensionality reduction for the selected neural network layer using the layer activations at the selected neural network layer comprises performing a dimensionality reduction technique that produces a spectrum of variances.

9. The method of claim 1, further comprising reinitializing the resized neural network prior to retraining the resized neural network.

10. A system comprising one or more computers and one or more storage devices storing instructions that are operable, when executed by the one or more computers, to cause the one or more computers to perform operations comprising:
obtaining data specifying a trained neural network, wherein the neural network comprises one or more neural network layers;
reducing a size of one or more of the neural network layers to generate a resized neural network, comprising:
selecting one or more neural network layers for resizing;
for each selected neural network layer:
determining an effective dimensionality reduction for the neural network layer, and
based on the determined effective dimensionality reduction, resizing the neural network layer; and
retraining the resized neural network.

11. The system of claim 10, wherein reducing a size of one or more of the neural network layers comprises reducing a respective number of units in each of the one or more neural network layers.

12. The system of claim 10, wherein determining an effective dimensionality reduction for the neural network layer comprises:
providing multiple data inputs to the neural network;
processing the input through the neural network layers to generate a respective layer activation at each neural network layer for each data input; and
determining an effective dimensionality reduction for the selected neural network layer using the network activations at the selected neural network layer.

13. The system of claim 12, wherein determining an effective dimensionality reduction for the selected neural network layer using the layer activation at the selected neural network layer comprises:
performing a Principal Components Analysis (PCA) on the layer activations to generate an eigenvalue spectrum for the network activation;
selecting a cut-off for the PCA eigenvalue spectrum; and
setting the effective dimensionality reduction as the number of cut-off PCA eigenvalue dimensions.

14. The system of claim 13, wherein selecting a cut-off for the PCA eigenvalue spectrum comprises selecting a cut-off based on a threshold of the cumulative variance of the PCA eigenvalue spectrum.

15. The system of claim 13, wherein selecting a cut-off for the PCA eigenvalue spectrum comprises selecting a cut-off level based on a flattening of the PCA eigenvalue spectrum.

16. The system of claim 13, wherein selecting a cut-off for the PCA eigenvalue spectrum comprises selecting a cut-off level based on a predetermined minimal PCA variance and size of the previous neural network layer readout weights.

17. The system of claim 12, wherein determining an effective dimensionality reduction for the selected neural network layer using the layer activations at the selected neural network layer comprises performing a dimensionality reduction technique that produces a spectrum of variances.

18. The system of claim 10, the operations further comprising reinitializing the resized neural network prior to retraining the resized neural network.

19. A computer program product encoded on one or more non-transitory storage media, the computer program product comprising instructions that when executed by one or more computers cause the one or more computers to perform operations comprising:
obtaining data specifying a trained neural network, wherein the neural network comprises one or more neural network layers;
reducing a size of one or more of the neural network layers to generate a resized neural network, comprising:
selecting one or more neural network layers for resizing;
for each selected neural network layer:
determining an effective dimensionality reduction for the neural network layer, and
based on the determined effective dimensionality reduction, resizing the neural network layer; and
retraining the resized neural network.

20. The computer program product of claim 19, wherein reducing a size of one or more of the neural network layers comprises reducing a respective number of units in each of the one or more neural network layers.
